(19) United States
(12) Patent Application Publication
(10) Pub. No.: US 2013/0072117 A1
(43) Pub. Date: Mar. 21, 2013

(54) DECOUPLED MULTI-LOOP WIDEBAND ANTENNAS FOR MAGNETIC COMMUNICATION

(71) Applicant: Sébastien Roland Bourdage, Dartmouth (CA)

(72) Inventor: Sébastien Roland Bourdage, Dartmouth (CA)

(21) Appl. No.: 13/608,611

(22) Filed: Sep. 10, 2012

Related U.S. Application Data
(60) Provisional application No. 61/535,044, filed on Sep. 15, 2011.

(51) Int. Cl. H01F 38/00; H04B 5/00

(52) U.S. Cl. 455/41.1; 307/104

(57) ABSTRACT

An antenna for magnetic communications and magnetic communications devices incorporating the antenna. The antenna includes two or more loops physically overlapping, wherein each loop is configured to be connected to one or more driving circuits, wherein the overlapping loops are symmetrically arranged around and overlap an antenna central point, each loop having a center point, wherein the center point of each loop is spaced apart by a distance from the center point of each adjacent loop, and wherein a distance of the loops from each other and from the antenna central point is selected to realize a local minimal mutual coupling

### CROSS-REFERENCE TO RELATED APPLICATIONS

The present application claims priority to U.S. provisional patent application Ser. No. 61/535,044, filed Sep. 15, 2011, and owned in common herewith, the contents of which are hereby incorporated by reference.

### FIELD

The present application generally relates to magnetic communication devices, systems, and methods, and more particularly to wideband magnetic communication using a decoupled multiple-loop antenna.

### BACKGROUND

Wireless communications in difficult environments are sometimes achieved using Magneto-Inductive (MI) technology. MI penetrates many mediums that normal RF waves cannot penetrate. This property is useful for environments in which RF communication is often blocked or attenuated, for example in mining, submarine or jammed (hostile) environments. MI works by establishing large AC magnetic fields. These fields are established at a low enough frequency that they penetrate conductive media. These ‘quasi-static’ fields have extremely small electric fields associated with them and do not propagate as electromagnetic waves until well outside the near field of the antenna.

MI communication devices typically use a large diameter loop antenna for transmission and reception. These antennas are essentially large air-cored inductors that establish the magnetic field or that receive/sense the magnetic field through induction.

An issue with MI communication is bandwidth. In order to create large magnetic fields, the loop antennas need to have a large magnetic moment. To create a large magnetic moment, the number of turns, loop area and currents must be large. Increasing turns and loop area increases the inductance of the loop antenna, and makes the antenna larger and more impractical from a portability standpoint. Increasing current also means that the voltage must be high as well. As inductance and current increases the voltage require to drive the loop antenna is extreme. In order to overcome some of the voltage problem, the antenna can be tuned using capacitors. Tuning allows the impedance of the system to be very small, but only at a certain frequency. This is acceptable for power amplifiers since a large current can be achieved without needing a large voltage, however the resulting antenna is very narrowband.

One approach that has been used is to switch capacitors to allow the narrowband loop antenna to be tuned at different frequencies; but this adds complexity to the system and restricts the types of modulation that can be implemented.

Another approach is to simultaneously use multiple loops tuned to different frequencies; however strong mutual magnetic coupling between the loops attenuates the output and causes the loops to behave as a single loop tuned antenna.

It would be advantageous to provide for an improved magnetic communication device, system or method.

### BRIEF DESCRIPTION OF THE DRAWINGS

Reference will now be made, by way of example, to the accompanying drawings which show example embodiments of the present application, and in which:

FIG. 1 shows an equivalent circuit for a magnetically coupled three-loop antenna and its frequency response;

FIG. 2 shows a graph illustrating the relationship between the distance between two overlapping loops and the degree of magnetic coupling;

FIG. 3 shows an equivalent circuit for a magnetically decoupled three-loop antenna and its frequency response;

FIG. 4 shows a graph containing the frequencies responses for the coupled and decoupled three-loop antennas;

FIG. 5 shows an example five loop antenna configuration;

FIG. 6 shows a graph of measured admittance of a prototype five-loop magnetically decoupled antenna;

FIG. 7 shows an example of a three-loop antenna;

FIG. 8 shows a diagrammatic example of a magnetic communication device employing one embodiment of the three-loop antenna; and

FIG. 9 shows another diagrammatic example of the magnetic communication device.

Similar reference numerals may have been used in different figures to denote similar components.

### DESCRIPTION OF EXAMPLE EMBODIMENTS

The present application describes a decoupled multiple-loop antenna for magnetic communications using magneto-inductive technology.

In one aspect, the present application describes antenna for magnetic communications. The antenna includes two or more loops physically overlapping, wherein the loops are each configured to be electrically connected to one or more driving circuits, wherein the overlapping loops are symmetrically arranged around and overlap an antenna central point, each loop having a center point, and wherein the center point of each loop is spaced apart by a distance from the center point of each adjacent loop, and wherein a spacing of the center points from each other and a distance of each center point from the antenna central point is selected to realize a local minimal mutual coupling.

In one aspect, the present application describes a three loop antenna, wherein the loops are circular with the same diameter and each is equally spaced apart from the two others by a distance that is a fixed ratio of their diameter.

In yet another aspect, the present application describes a five or more loop antenna wherein the loops are ellipses with their major axes passing through the central point.

In yet a further aspect, the present application describes a magnetic communication device having an antenna as described herein.

Other aspects and features of the present application will be understood by those of ordinary skill in the art from a review of the following description of examples in conjunction with the accompanying figures.

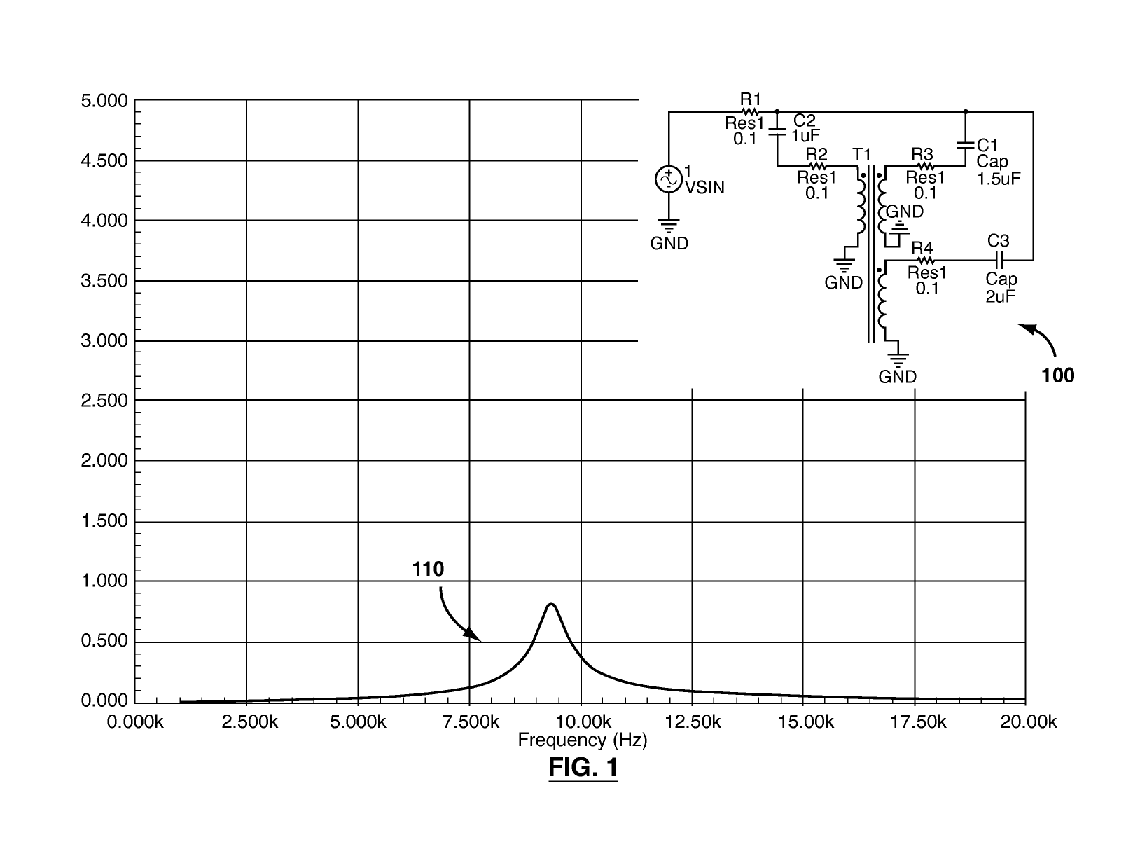

As noted above, multiple loop antennas driven with different signals present a problem of mutual magnetic coupling when driven together. An example equivalent circuit 100 for a tuned three-loop antenna with tuning capacitors is shown in FIG. 1. The three-loops are tuned to different resonant frequencies, for example based upon the differing values of the capacitors placed in series with each respective loop. The actual values shown in the Figure are for example purposes only.

FIG. 1 further includes a graph indicating the frequency response 110 of such an antenna. It will be noted from the graph that the three-loop antenna appears as a single loop antenna with a single resonant frequency. In addition to having a single narrowband resonance, the response is severely attenuated.

Accordingly, the present application proposes an MI communications system, device and methods employing decoupled multi-loop antennas. One mechanism for decoupling the loops is to space them a large distance apart so that there is no or little magnetic coupling; however, this is impractical for most implementations.

When two loops are oriented in the same plane and have coaxial or near-coaxial centers, the two loops have strong positive mutual coupling. If the two loops are next to each other in the same plane, i.e. side-by-side, the two loops have a weaker negative coupling. It has thus been noted that between these two orientations there is a certain offset between the centers of the loops that will result in zero mutual coupling.

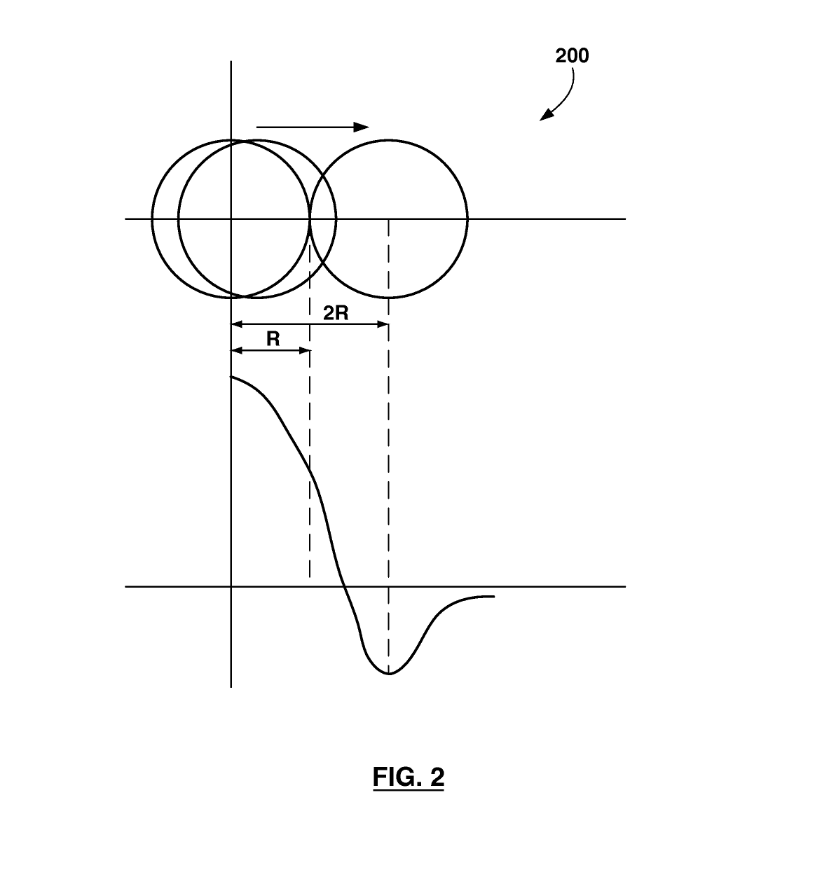

FIG. 2 illustrates this graphically. FIG. 2 shows a graph 200 of the mutual magnetic coupling for two loops in a common plane. The x-axis shows the distance between the centers of the two loops. It will be noted that the zero coupling point lies between an offset of R and 2R, where R is the radius of the loops. Accordingly, with two circular loops one can space them a certain distance apart, but partially overlapped, to realize zero coupling. The precise distance is dependent upon the geometry of the loops.

Accordingly, a decoupled multi-loop antenna may be formed using two partially-overlapped loops having center points spaced apart from each other by a distance that produces zero coupling. In one embodiment, a different tuning capacitor is placed in series with each loop so that the two loops will have different resonant frequencies, thereby realizing multi-band operation. In another embodiment, the loops may be left un-tuned and may be separately driven by power amplifiers using wide-band signals.

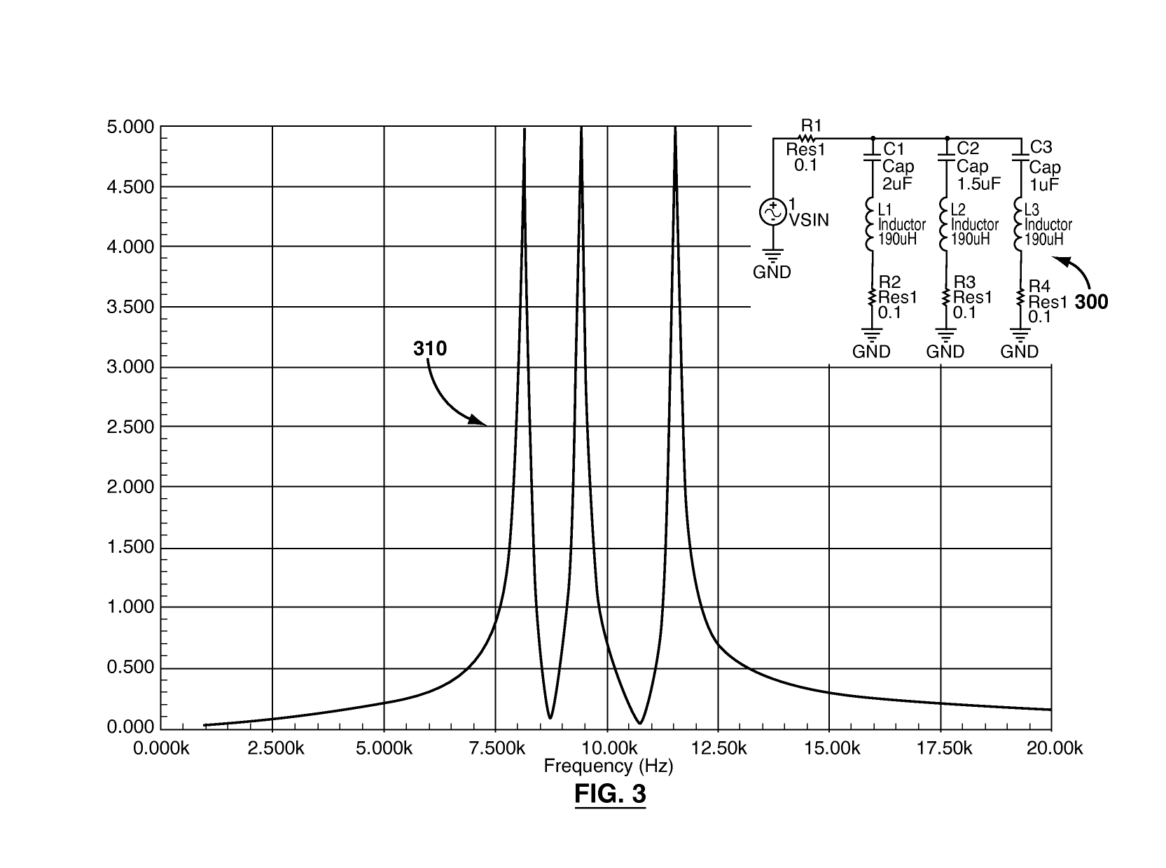

Taking advantage of this property of two loops, an antenna can also be formed from three loops, each spaced apart from each other by a distance that produces zero coupling, i.e. the “zero coupling distance”. This may be modeled as shown in FIG. 3, which shows an equivalent circuit 300 and a graph of the frequency response 310. It will be noted from the frequency response 310 that the three decoupled loops result in an antenna configuration that has three distinct resonant frequencies.

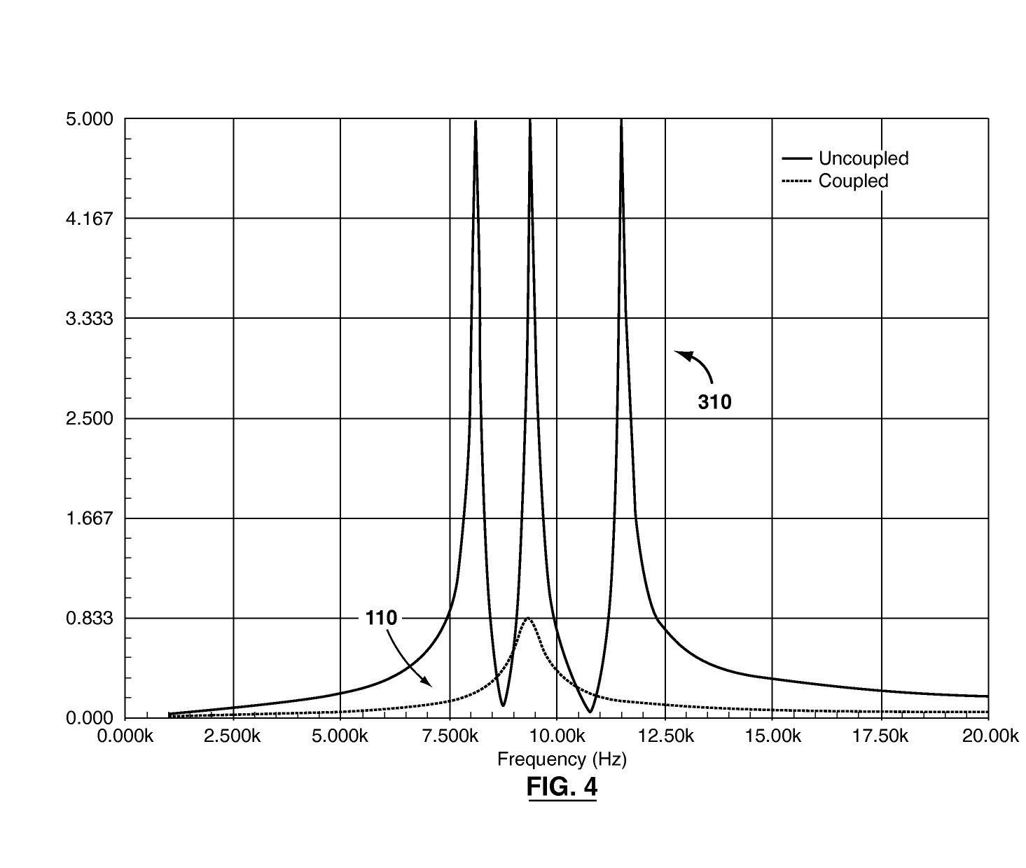

FIG. 4 show the frequency response 310 of the decoupled loops from FIG. 3 together with the frequency response 110 of the coupled loops from FIG. 1. The relative difference in the magnitudes of the responses is notable.

In the example of the three-loop antenna, each loop has the same inductance but has a different-sized capacitor in series such that each loop has the same magnetic moment but different tuning frequencies. Without the coupling, each loop can freely transmit in its own frequency channel.

Although the overall system response appears to be wideband, the transient response of each channel is very significant when operating at MI frequencies. This means that if a simple amplifier is to be used, then each frequency may run for a minimum number of cycles (or time) so that the magnetic moment has time to build to maximum amplitude. If, however, each channel has its own complex switching system, then more significant bitrates can be achieved for each channel. An example switching system is described in U.S. Pat. No. 6,882,236, granted Apr. 19, 2005 and owned in common herewith. The contents of U.S. Pat. No. 6,882,236 are hereby incorporated by reference.

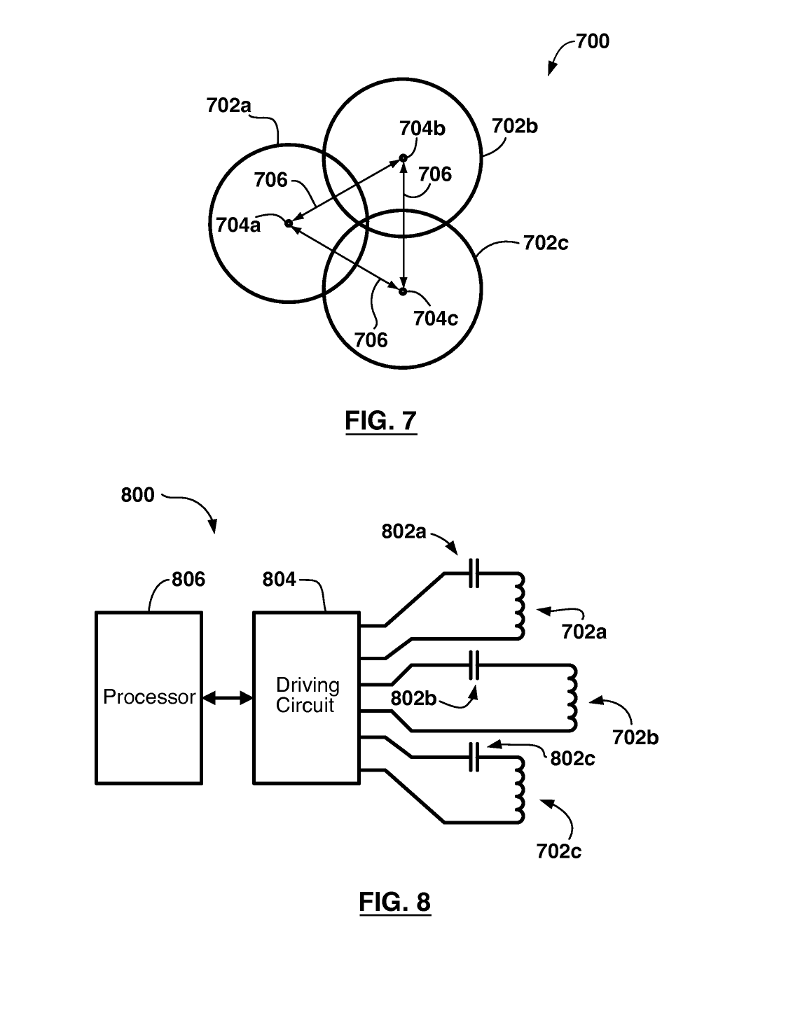

FIG. 7 diagrammatically shows one example of a three-loop antenna 700. The three-loop antenna 700 is formed from three partially-overlapping loops 702a, 702b, 702c. The center points 704a, 704b, 704c of the three loops are spaced equidistant from each other at a distance 706 that realizes zero coupling (or, put another way, local-minimal coupling). The three loops 702a, 702b, 702c, lie in substantially the same plane.

In some embodiments, the antenna may feature more than three loops. The three loop antenna is simple in that it features three equally-spaced loops around a common center point, where each loop has a center equidistant from the centers of the other loops. When constructing an antenna with more than three loops, different loop geometry may be used to realize minimal coupling between the loops. For example, instead of using circles, the loops may themselves be shaped as ellipses or ovoids.

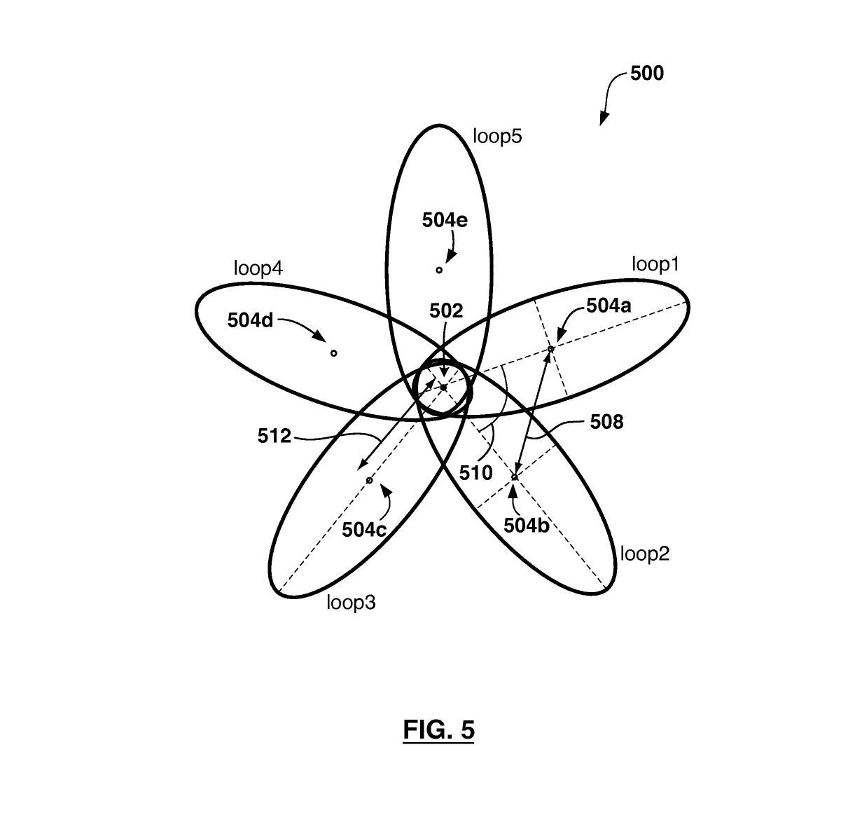

As an example, FIG. 5 illustrates an antenna 500 having five elliptical loops lying in a common plane and symmetrically arranged around a common center point 502. As an ellipse, each loop has a major axis (length) and a minor axis (width), which cross at a center point 504 (individually labeled 504a, 504b, 504c, 504d, and 504e). The loops are all spaced equally apart from their immediate neighbours, meaning the angles 510 between the major axes of adjacent loops are the same. In other words, a distance 508 between the center point 504a of loop 1 and the center point 504b of loop 2 is the same as the distance between the center points 504 of all adjacent loops.

There are two degrees of freedom in the five-elliptical-loop antenna 500: the ratio of loop length to loop width (i.e. the loop geometry) and the distance 512 from the antenna center point 502 to the individual loop center points 504. Given the symmetry of the antenna 500, it is possible to arrive at a configuration that minimizes the mutual coupling in the antenna 500 by considering the coupling between three of the loops. For example, the coupling between loop 1 and loop 2 and between loop 1 and loop 3 may be analyzed and a minimization of those two couplings will result in a minimal coupling as between all five loops.

The mutual coupling between two loops is proportional to the flux through one loop caused by a current flowing in the other loop. Accordingly, an antenna design solution can be found using optimization techniques to solve an expression that models the flux through an ellipse caused by another ellipse. In the following description, the ellipse being analyzed may be referred to as the “subject ellipse” or “recipient ellipse” and the ellipse causing the magnetic field that acts upon the recipient ellipse is referred to as the “source ellipse”.

The flux through a surface defined by a closed line can be determined using a line integral of magnetic potential. The magnetic potential of a line current can be expressed as:

$$\vec{A} = \int \frac{{μ}_{0} I d \vec{l}}{4 π \vert r - {r}^{′} \vert} \qquad ( 1 )$$

The flux is then expressed as:

$$Ψ = {∮}_{L} [ \int \frac{μ I d \vec{{l}_{S}}}{4 π \vert \vec{r} - \vec{{r}^{′}} \vert} ] \cdot d \vec{{l}_{R}} \qquad ( 2 )$$

where Ψ is the flux through the recipient ellipse, μ is the magnetic permeability of the medium in which the loops are embedded or immersed, I is the current in the source ellipse, \vec{r} is a vector describing the recipient ellipse perimeter, \vec{r¹} is a vector describing the source ellipse perimeter, d\vec{l_{R}} is a differential element vector describing the recipient ellipse line tangent, and d\vec{l_{S}} is a differential element vector describing the source ellipse line tangent. With a suitable coordinate transformation, the integrals of Equation (2) may be rendered more tractable.

One possible objective in the design of a multi-loop antenna is to dampen the resonance peaks enough to flatten the antenna transfer function, while not losing too much of the resonant gain. This should result in a broadband antenna with in-band gain and a flat response.

In accordance with one aspect of the present application, a suitable magnetically decoupled multi-loop antenna is realized through partially overlapping the loops around a common center, but symmetrically spacing the loops apart. The precise distance apart to realize local-minimal magnetic coupling will depend on the loop geometry.

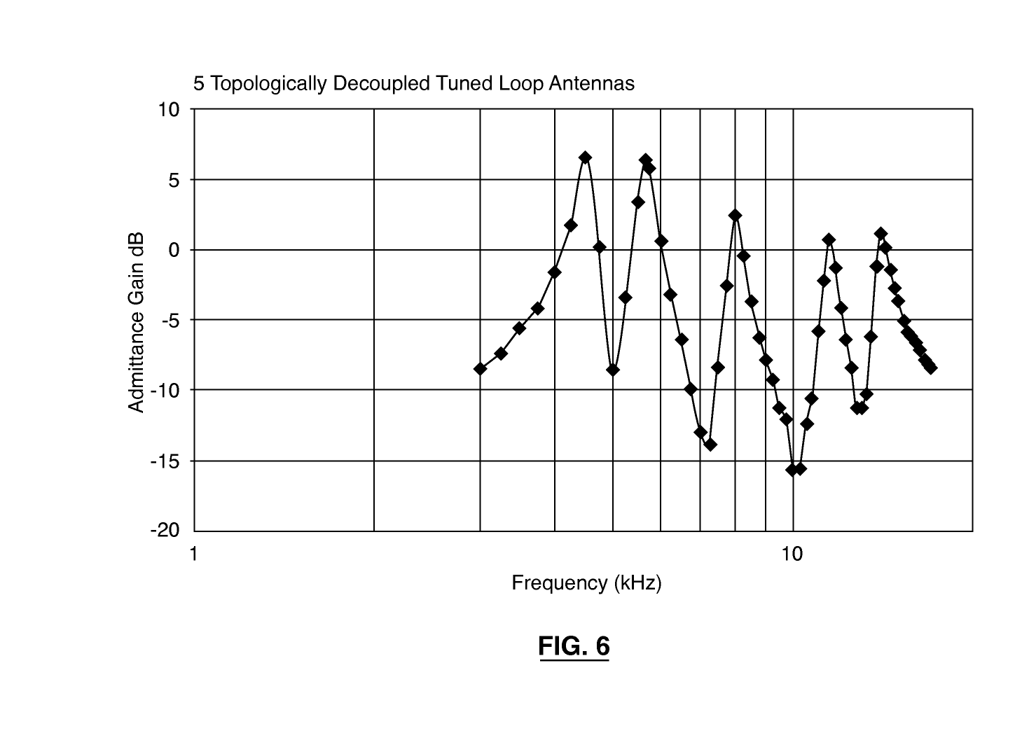

Experimental results below are based upon a prototype tuned 5-loop antenna that was constructed and tested. One loop was energized with a sine wave while other loops were observed for induced e.m.f. FIG. 6 shows a graph 600 of the measured admittance of the prototype antenna when tuned with capacitors at different frequencies. It will be noted that there are five distinct peaks in the graph 600 corresponding to the five resonant frequencies of the loops.

It will be understood that suitable antenna configurations may be found for fewer than five or more than five elliptical loops with appropriate loop geometry and partial overlapping.

It will be appreciated that the antennas described herein are intended for use in MI communications systems or devices, and that, in some embodiments, suitable switching circuits may be used to drive the individual loops of the antennas at selected frequencies. It will also be understood that MI communications are magnetic field-based communications that typically use frequencies near or below 10 kHz and, at times, between 500 and 3000 Hz; however, in some applications, MI communications system may use other frequencies.

Reference is now made to FIG. 8, which shows, in simplified block diagram form, one example magnetic communication device 800. The device 800 includes the three-loop antenna formed from the three partially-overlapping loops 702a, 702b, 702c. This example involves a tuned antenna. In this case, each of the loops is connected in series with a tuning capacitor 802a, 802b, 802c, to tune each respective loop to its respective resonant frequency. The loops 702a, 702b, 702c are connected to a driving circuit 804 for detecting induced signals or for generating transmission signals for driving the loops 702a, 702b, 702c. A processor 806 operating under program control may control operation of the driving circuit 804.

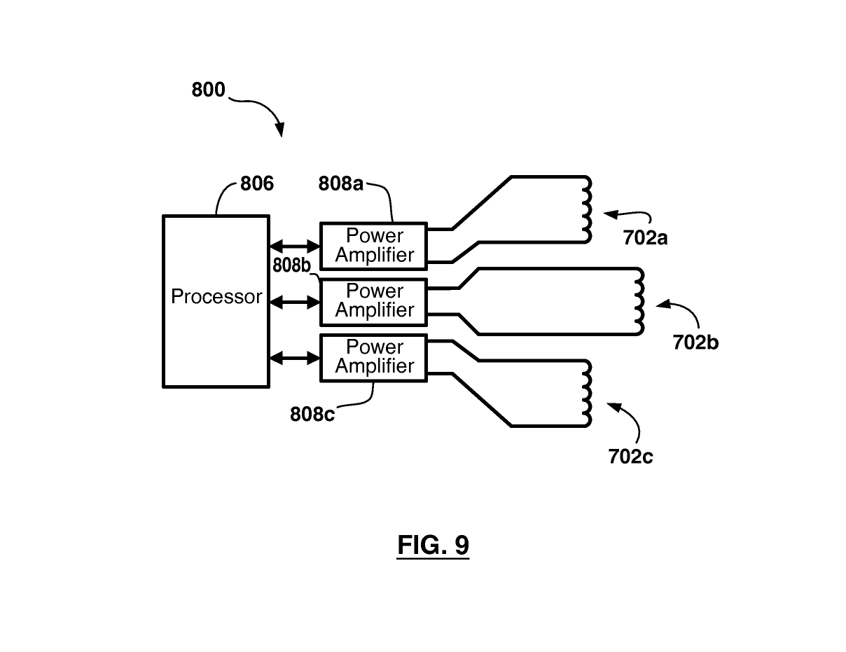

Now reference will be made to FIG. 9, which shows another example embodiment of the magnetic communication device 800. In this embodiment, the loops 702a, 702b, and 702c are not tuned by tuning capacitors. Instead each loop, in this example, is driven by a respective power amplifier 808a, 808b, 808c. Normally, when driving magnetic loop antennas with a power amplifier a very high voltage is required and the system encounters high peak/average power ratio problems (high crest factor). In this case, however, the decoupling permits each loop to operate substantially independently, which reduces the crest factor problem by multiplexing through multiple loops instead of one.

It will also be appreciated that the geometric shape of the loops may be altered somewhat without materially affecting the operation of the antenna. For example, the loops need not be perfectly elliptical. For instance, in one implementation the loops may be oval or egg-shaped (ovoid). The term “ellipse” in this application is intended to encompass all non-circular closed loops, including ovals, egg-shapes (ovoids), and more irregular ellipse-like shapes.

Certain adaptations and modifications of the described embodiments can be made. Therefore, the above discussed embodiments are considered to be illustrative and not restrictive.

What is claimed is:

1. An antenna for magnetic communications, the antenna comprising:
two or more loops physically overlapping,
wherein each loop is configured to be connected to one or more driving circuits,
wherein the overlapping loops are symmetrically arranged around and overlap an antenna central point, each loop having a center point, and wherein the center point of each loop is spaced apart by a distance from the center point of each adjacent loop,
and wherein a spacing of the center points from each other and a distance of each center point from the antenna central point is selected to realize a local minimal mutual coupling.

2. The antenna claimed in claim 1, further comprising a capacitor connected in series with each of the two or more loops, each of the capacitors having a different value from each of the other capacitors such that each of the loops has a different resonant frequency.

3. The antenna claimed in claim 1, wherein the two or more loops comprise three loops, and wherein the center points of the three loops are equally spaced apart.

4. The antenna claimed in claim 3, wherein the loops are circular and have the same diameter.

5. The antenna claimed in claim 4, wherein the distance of each center point from each of the other two center points is a fixed ratio of the diameter.

6. The antenna claimed in claim 1, wherein the two or more loops comprise five loops, and wherein the loops are ellipses each having a major axis and a minor axis that meet at the center point of that loop, and wherein the major axis of each of the loops passes through the central point, and the major axes of each two adjacent loops are set at a fixed angle relative to each other.

7. The antenna claimed in claim 6, wherein the center point of each loop is spaced a distance apart from the central point that is less than half the major axis length.

8. The antenna claimed in claim 1, wherein each of the loops has the same geometric shape.

9. The antenna claimed in claim 8, wherein the geometric shape of each of the loops is circular, elliptical, oval, or ovoid.

10. A magnetic communication device, comprising:
the antenna claimed in claim 2;
a processor;
a driving circuit connected to the antenna and configured to drive the antenna at the resonant frequencies under control of the processor.

11. A magnetic communication device, comprising:
the antenna claimed in claim 1;
a processor;
a power amplifier, operating under control of the processor, and connected to each respective loop and configured to drive its respective loop with a wideband signal.
